(19) United States
(12) Patent Application Publication
(10) Pub. No.: US 2009/0164256 A1
(43) Pub. Date: Jun. 25, 2009

(54) DEVICE, SYSTEM, AND METHOD OF COLLABORATIVE INSURANCE

(75) Inventors: Amit Fisher, Nesher (IL); Daniel M. Yellin, Raanana (IL)

Correspondence Address: SUGHRUE MION PLLC;USPTO CUSTOMER NO WITH IBM/SVL, 2100 PENNSYLVANIA AVENUE, N.W., WASHINGTON, DC, 20037, US

(73) Assignee: INTERNATIONAL BUSINESS MACHINES, Armonk, NY (US)

(21) Appl. No.: 11/960,766

(22) Filed: Dec. 20, 2007

(51) Int. Cl. G06Q 40/00

(52) U.S. Cl. 705/4

(57) ABSTRACT

Device, system and method of collaborative insurance. For example, a system for electronic insurance transactions includes: a server to receive a risk description posted through a customer terminal, to publish the risk description to one or more insurer terminals, and to determine whether or not to underwrite an insurance covering at least a portion of a risk included in the risk description based on an analysis of aggregated data, wherein the aggregated data comprises data related to said risk description and data related to one or more other posted risk descriptions.

### FIELD

Some embodiments of the invention are related to the field of electronic systems for insurance transactions.

### BACKGROUND

Some electronic systems and Internet web-sites may be utilized to facilitate insurance transactions. For example, a user may use the Internet to access a web-site of a particular insurance company, and to submit online a request for a quote for insuring a pre-defined risk, e.g., a risk associated with a vehicle or a home of the user. The user may be required to enter various personal details associated with the user (e.g., age, gender, marital status, or the like), as well as various details associated with the risk for which insurance coverage is sought (e.g., maker and model of the vehicle, year of manufacture of the vehicle, or the like).

In some systems, an agent of the insurance company may manually review the data entered by the user and may manually calculate an insurance quote. In other systems, a pre-defined algorithm may be used to automatically calculate the insurance quote based on the data entered by the user. After the insurance quote is calculated (manually or automatically), the insurance company may provide to the user the insurance quote (e.g., premium amount, coverage amount, and other terms) through the electronic system.

### SUMMARY

Some embodiments of the invention include, for example, devices, systems and methods of collaborative insurance.

In some embodiments, a system for electronic insurance transactions includes: a server to receive a risk description posted through a customer terminal, to publish the risk description to one or more insurer terminals, and to determine whether or not to underwrite an insurance covering at least a portion of a risk included in the risk description based on an analysis of aggregated data, wherein the aggregated data includes data related to the risk description and data related to one or more other posted risk descriptions.

In some embodiments, a method for electronic insurance transactions includes: receiving a risk description posted through a customer terminal; publishing the risk description to one or more insurer terminals; and determining whether or not to underwrite an insurance covering at least a portion of a risk included in the risk description based on an analysis of aggregated data, wherein the aggregated data includes data related to the risk description and data related to one or more other posted risk descriptions.

In some embodiments, a server computer includes: a risk-posting module to receive risk descriptions from customer terminals; a database to store posted risk descriptions; a retrieval interface to selectively present on the insurer terminal a risk-of-interest based on a risk profile; a question-posting module to receive from an insurer terminal a question related to the risk-of-interest; and an answer-posting module to receive from one or more customer terminals one or more answers to the question.

Some embodiments may include, for example, a computer program product including a computer-useable medium including a computer-readable program, wherein the computer-readable program when executed on a computer causes the computer to perform methods in accordance with some embodiments of the invention.

Some embodiments of the invention may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments of the invention.

FIG. 2 is a schematic flow-chart of a method of collaborative insurance in accordance with some demonstrative embodiments of the invention.

### DETAILED DESCRIPTION

In the following detailed description, numerous specific details are set forth in order to provide a thorough understanding of some embodiments of the invention. However, it will be understood by persons of ordinary skill in the art that embodiments of the invention may be practiced without these specific details. In other instances, well-known methods, procedures, components, units and/or circuits have not been described in detail so as not to obscure the discussion.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein includes, for example, “multiple” or “two or more”. For example, “a plurality of items” includes two or more items.

Although portions of the discussion herein relate, for demonstrative purposes, to wired links and/or wired communications, embodiments of the invention are not limited in this regard, and may include one or more wired or wireless links, may utilize one or more components of wireless communication, may utilize one or more methods or protocols of wireless communication, or the like. Some embodiments of the invention may utilize wired communication and/or wireless communication.

Some embodiments of the invention may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device (e.g., a device incorporating functionalities of multiple types of devices, for example, PDA functionality and cellular phone functionality), a vehicular device, a non-vehicular device, a mobile or portable device, a non-mobile or non-portable device, a wireless communication station, a wireless communication device, a wireless Access Point (AP), a wireless Base Station, a Mobile Subscriber Station (MSS), a wired or wireless Network Interface Card (NIC), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11g, 802.11n, 802.16, 802.16d, 802.16e, 802.16m standards and/or future versions and/or derivatives and/or Long Term Evolution (LTE) of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or tag or transponder, a device which utilizes Near-Field Communication (NFC), a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a wired or wireless handheld device (e.g., BlackBerry, Palm Treo), a Wireless Application Protocol (WAP) device, or the like.

Some embodiments of the invention may be used in conjunction with one or more types of wireless communication signals and/or systems, for example, Radio Frequency (RF), Infra Red (IR), Frequency-Division Multiplexing (FDM), Orthogonal FDM (OFDM), OFDM Access (OFDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), Global Positioning System (GPS), IEEE 802.11 (“Wi-Fi”), IEEE 802.16 (“Wi-Max”), ZigBee™, Ultra-Wideband (UWB), Global System for Mobile communication (GSM), 2G, 2.5G, 3G, Third Generation Partnership Project (3GPP), 3.5G, or the like. Embodiments of the invention may be used in various other devices, systems and/or networks.

The term “insurance” as used herein includes, for example, hedging against a risk of a contingent loss; an equitable transfer of the risk of loss from a first entity to a second entity in exchange for a premium; a mechanism or a service to indemnify or compensate an injured customer for damages or loss arising from a contingent event or a risk; or the like.

Some embodiments may be used in conjunction with one or more types of insurance, for example, automobile insurance; aviation insurance; boiler and machinery insurance; equipment breakdown insurance; Builder's risk insurance; business insurance; professional liability insurance; professional indemnity insurance; Business Owners Policy (BOP) insurance; casualty insurance; credit insurance; loan insurance; crime insurance; crop insurance; Defense Base Act (DBA) workers' compensation insurance; directors and officers liability insurance; disability insurance; errors and omissions insurance; liability insurance; expatriate insurance; financial loss insurance; business interruption insurance; fire insurance; property insurance; hazard insurance; health insurance; kidnap and ransom insurance; home insurance; homeowner insurance; environmental liability insurance; life insurance; locked fund insurance; marine insurance; marine cargo insurance; mortgage insurance; national insurance; no-fault insurance; nuclear incident insurance; pet insurance; political risk insurance; pollution insurance; prize indemnity insurance; protected self-insurance; retrospectively rated insurance; formal self insurance; social insurance; stop-loss insurance; terrorism insurance; title insurance; travel insurance; volcano insurance; earthquake insurance; flood insurance; or the like.

The terms “customer”, “insurance customer” and “insured” as used herein include, for example, one or more persons or entities that purchase insurance; one or more persons or entities that seek or request to purchase insurance; one or more persons or entities that offer to purchase insurance; one or more persons or entities that request insurance quote(s); one or more persons or entities that are prospective insured or candidate insured; one or more persons or entities that purchased insurance; or the like.

The terms “insurer”, “insurance company” and “underwriter” as used herein include, for example, one or more persons or entities that sell insurance; one or more persons or entities that provide insurance coverage; one or more persons or entities that offer insurance coverage; one or more persons or entities that provide insurance quotes; one or more persons or entities that underwrite risks; a syndication or multiple insurance companies or underwriters; reinsurance companies or re-insurers; captive insurance companies; life insurance companies; non-life insurance companies; general insurance companies; standard line insurance companies; excess line insurance companies; or the like.

The term “insurance quote” or “quote” as used herein includes, for example, information associated with an insurance offer, e.g., insurance premium amount, insurance coverage amount, insurance period, terms for payment of the premium, terms for payment of insurance coverage amount, terms and conditions of insurance policy, or the like.

At an overview, some embodiments of the invention provide devices, systems and method of collaborative insurance.

For example, an electronic insurance clearinghouse system allows a customer (e.g., an individual or organization) to describe a risk for which the customer would like to purchase insurance, even if the risk is not currently covered by any standard or pre-defined insurance policy. One or more insurance companies (or other accredited organizations) may review the risks posted by customers, aggregate the risks or the customers as appropriate, price the risks, and electronically provide to the customer an insurance quote. The customer may accept the quote, and an insurance policy is then issued accordingly. Optionally, the insurance company and/or the insured may determine to split the coverage among multiple insurers, in order to reduce the risk associated with each insurer.

In some embodiments, the posted risk may be new and unfamiliar to insurance companies, which may lack sufficient experience or information in order to determine how to appropriately underwrite such risk. Insurance companies may utilize the electronic system (e.g., optionally using “Web 2.0” architecture or components) in order to pose questions to the customer, to other customers, to experts, to users familiar with the customer, to users familiar with the risk, to other insurers, or the like. The system may thus harness the distributed expertise of multiple individuals in order to help evaluate the actual characteristics of the risk for which insurance is sought. Optionally, using the Web, a poll of experts may be used to ascertain or to better estimate the level of risk involved, or to estimate one or more characteristics or properties of the risk (e.g., frequency of occurrence, average damage from the risk, or the like). Optionally, a rating mechanism is used for risk calculation, e.g., with regard to the insurer and/or the customer.

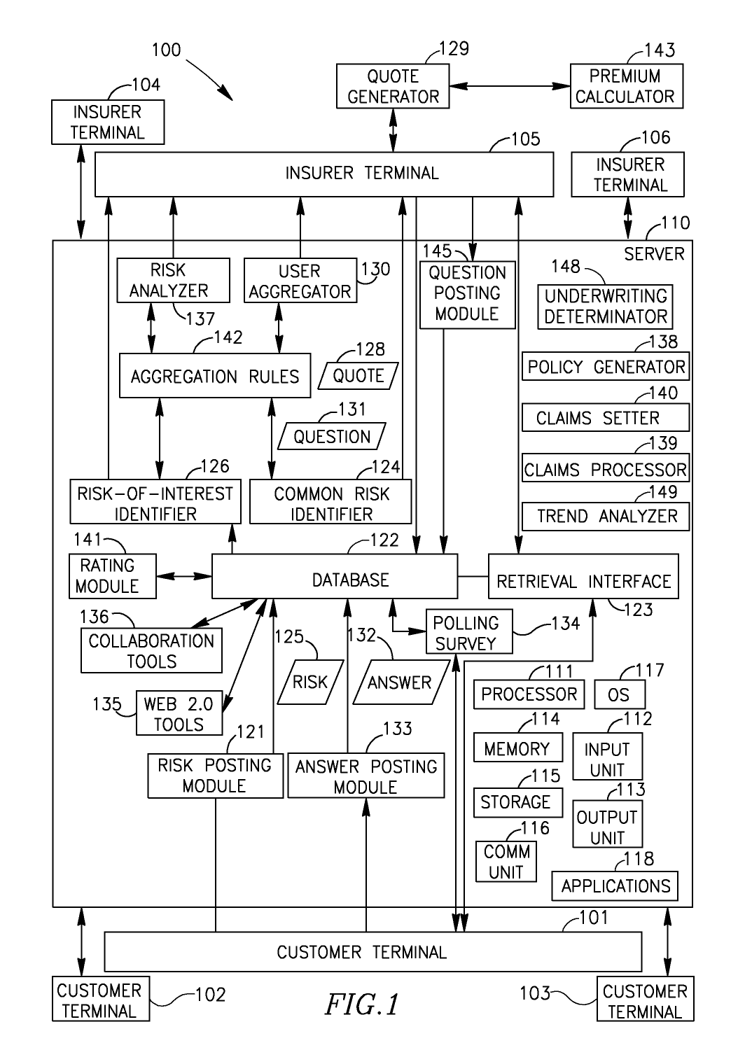

FIG. 1 schematically illustrates a block diagram of a system 100 in accordance with some demonstrative embodiments of the invention. System 100 includes a server 110 able to communicate through wired and/or wireless links with one or more customer devices or terminals (e.g., customer terminals 101-103), as well as with one or more insurer devices or terminals (e.g., insurer terminals 104-106).

Terminals 101-106 may include one or more types of devices able to perform at least a portion of an electronic commerce transaction. For example, each one of devices 101-106 may be a desktop computer, a laptop computer, a PDA device, a cellular phone, an electronic commerce (e-commerce) terminal, or the like.

Server 110 includes, for example, a processor 111, an input unit 112, an output unit 113, a memory unit 114, a storage unit 115, and a communication unit 116. Server 110 optionally includes other suitable hardware components and/or software components.

Processor 111 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or other suitable multi-purpose or specific processor or controller. Processor 111 executes instructions, for example, of an Operating System (OS) 117 or of one or more applications 118.

Input unit 112 includes, for example, a keyboard, a keypad, a mouse, a touch-pad, a joystick, a track-ball, a stylus, a microphone, or other suitable pointing unit or input device. Output unit 113 includes, for example, a monitor, a screen, a Cathode Ray Tube (CRT) display unit, a Liquid Crystal Display (LCD) display unit, a plasma display unit, one or more audio speakers or earphones, or other suitable output devices.

Memory unit 114 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 115 includes, for example, a hard disk drive, a floppy disk drive, a Compact Disk (CD) drive, a CD-ROM drive, a Digital Versatile Disk (DVD) drive, an internal or external database or data repository, or other suitable removable or non-removable storage units. Memory unit 114 and/or storage unit 115, for example, store data processed by server 110.

Communication unit 116 includes, for example, a wired or wireless transceiver, a wired or wireless modem, a wired or wireless Network Interface Card (NIC), or other unit suitable for transmitting and/or receiving communication signals, blocks, frames, transmission streams, packets, messages and/or data. Communication unit 116 optionally includes one or more antennas.

In some embodiments, some or all of the components of server 110 are enclosed in a common housing or packaging, and are interconnected or operably associated using one or more wired or wireless links. In other embodiments, components of server 110 are distributed among multiple or separate devices or locations.

Server 110 operates as an electronic clearinghouse to allow collaborative insurance in accordance with some embodiments of the invention. Server 110 allows real-time and asynchronous communication among insurers and customers, and performs operations allowing the insurers to more accurately estimate the risk for which a customer seeks insurance.

For demonstrative purpose, some non-limiting examples are discussed herein to demonstrate the functionality and the operation of system 100; other suitable insurance transactions may be performed or facilitated using system 100.

In a first demonstrative example, a customer hires a contractor to build a house for the customer. The customer seeks to purchase insurance for the risk that the contractor does not complete building the house according to the agreed schedule. In particular, the customer is exposed to the risk of being required to rent another house if the contractor does not complete the building in time.

The customer utilizes the customer terminal 101 in order to electronically post onto system 110 a description of the risk for which the customer seeks insurance. This may be performed, for example, using a risk posting module 121, e.g., a Web-based interface or a Web 2.0 interface in which the customer enters textual description of the risk and the insurance coverage sought, and optionally uploads files (e.g., photographs, audio/video files, documents, or the like. A posted risk 125 is thus generated stored in a database 122 along with other risk descriptions posted by other customers.

In some embodiments, optionally, the customer may only provide partial information or a partial description of the risk, for example, due to privacy reasons or confidentiality considerations. In such cases, the insurer, if potentially interested in underwriting the partially-described risk, contacts the customer in order to obtain additional details. Alternatively, the customer may limit in advance the entities that have access to his posting, and/or may select or define a set of viewers based on one or more criteria; for example, the customer may limit access to his posted risk 125 only to insurers (e.g., and not to other customers); only to insurers that have a pre-defined rating (e.g., insurers that are rated AA or higher by Standard and Poor's); only to insurers that have a license to insure in a particular state or country; only to insurers that meet particular conditions (e.g., insurers that are in business for at least five years); or other criteria.

The posted risk descriptions may be retrieved, browsed, reviewed or read by other customers and/or by insurers, for example, using a retrieval interface 123 (e.g., a Web browser, a Web 2.0 browser, or the like). For example, in some embodiments, risk descriptions are associated with tags or keywords or risk-specific categories and attributes; in other embodiments, risk descriptions are browse-able or search-able (e.g., using free-text search or using keyword search). In some embodiments, risk descriptions are organized using an online forum mechanism, an online “blog” mechanism, an online chat-room mechanism, or the like. Accordingly, customers and/or insurers may search, retrieve, and selectively review one or more risk postings. Risks may be discussed and debated by selected distributed teams, for example, using Web 2.0 technologies or components.

In some embodiments, an insurer manually reviews the posted risk descriptions, and identifies a significant number of similar risk postings over time. In other embodiments, a common risk identifier module 124 periodically scans the database 122 and automatically identifies a common risk, namely, a significant number of similar or associated risk postings over time; for example, if a significant number of postings mention “rent insurance”. In some embodiments, for example, the common risk identifier module 124 may determine and return a set of risk postings that are categorized as “weather-related risk” and are also located in the “State of Texas”. For example, the common risk identifier module 124 may automatically aggregate similar insurance requests or risk descriptions posted by multiple customers; and the insurer may thus locate a sufficient number of individual yet similar requests to aggregate the common risk across multiple similar policies. The common risk identifier module 124 may retrieve risks with different degrees of similarity (e.g., “all weather-related risks” or only “weather-related risks in the same geographical unit”).

In some embodiments, a trend analyzer module 149 periodically or frequently analyzes the information in database 122, and identifies trends or patterns across risk postings. For example, the trend analyzer module 149 may determine that there exist significantly more risk postings for animal-related insurance in the last month or year. The trend analysis results may be used by actuaries, underwriters, and marketers associated with an insurer, for example, in order to consider new insurance products to offer in the marketplace.

In some embodiments, a mechanism allows customers and/or insurers to search for risks that are similar to another particular risk; for example, the user may command the system to “find risks similar to R”, where R is a description of a specific risk.

In some embodiments, a risk-of-interest identifier module 126 periodically scans the database 122 and automatically identifies a risk-of-interest, for example, based on keywords or categories defined by the insurer (e.g., “ransom insurance”), or based upon the common attributes of different risks found by the common risk identifier module 124. For example, an insurer specializing in insuring 18th century art works may search for posted risk descriptions that include “art works” or “18th century”.

Some embodiments may allow insurers to identify a common risk or a risk-of-interest, optionally using contextual analysis, keywords, tags, pre-defined aggregation rules 142, dynamically generated aggregation rules, free-text search, or the like. For example, in some embodiments, the common risk identifier module 124 includes a mechanism for an insurer to discover a common risk across multiple postings; and the risk-of-interest identifier module 126 includes a mechanism for an insurer, upon defining risk criteria, to locate additional risk postings that meet the defined profile. In some embodiments, optionally, an insurer may utilize the results returned by the common risk identifier module 124, as a basis for further analysis and for defining a risk profile of interest, to be used by the risk-of-interest identifier module 126. Upon definition of a risk profile of interest, the risk-of-interest identifier module 126 searches for and locates the risk descriptions that match the defined profile.

Once the insurer identifies a common risk or a risk-of-interest, the insurer may determine to offer insurance coverage for that risk. The insurer utilizes the insurer terminal 105 to post an insurance quote 128, which may be stored in the database 122 and may be retrieved using the retrieval interface 123. Optionally, the insurance quote 128 is directly transferred to one or more users, or directly brought to the attention of one or more users, to which the insurance quote 128 is particularly related (e.g., users that posted risk descriptions that the insurance quote 128 relates to).

In some embodiments, the insurance quote 128 may be generated manually by the insurer, and then transmitted electronically using the insurer terminal 105. In other embodiments, an insurance quote generator 129 automatically generates the insurance quote 128, for example, based on pre-defined algorithm. For example, the algorithm may search for risk descriptions including a particular keyword (e.g., “ransom”); and may use a pre-defined formula to generate insurance quotes for this type of insurance (e.g., a premium amount equals to one percent of the insurance coverage amount, per year). Optionally, the pre-defined algorithm is implemented using a premium calculator module 143. In some embodiments, the algorithm may identify that the risk matches the criteria for an existing type of insurance policy, and may generate an insurance quote 128 for the risk using the rules or parameters for that type of insurance policy.

Upon reception of the insurance quote, the customer determines whether or not to accept the insurance quote 128 and conveys his response using the customer terminal 101. If the customer accepts the insurance quote 128, an insurance contract or insurance policy may be formed. If the customer rejects the insurance quote 128, the insurer may be notified and may modify the insurance quote 128 to better accommodate the request of the customer. In some embodiments, a syndication of multiple insurers may be formed in order to underwrite together a single risk, or a type of risks; for example, each insurer in the syndication receives a portion of the insurance premium collected, and each insurer in the syndication is obligated to pay a portion of the insurance amount in the future.

In some embodiments, in order to more efficiently underwrite an unfamiliar type risk, one or more insurers may utilize the server 110 (e.g., utilizing Web-based architecture or Web 2.0 components) to obtain additional information related to the risk (e.g., information about local house contractors). The insurer may post, through a question posting module 145, an insurance-related question 131, which may be stored in the database 122 and may be retrieved using the retrieval interface 123. For example, question 131 may be “If you hired the house contractor John Smith, did he complete the project on time?”. Users of system 100 may post responses to the question 131. For example, an answer 132 may be posted by the customer terminal 101 to the database 122 through an answer posting module 133, and may be retrieved using the retrieval interface 123. The posted answers may assist the insurer to more efficiently underwrite the risk and to more accurately price the individual insurance policies.

In some embodiments, the question 131 and one or more answers 132 may utilize a free-text mechanism. In other embodiments, an online polling or survey mechanism 134 may be used for posing questions 131 and collecting answers 132, for example, using a Web-based interface, radio buttons, drop down lists, or the like. Data collected by the polling or survey mechanism 134 may be added to the database 122, and/or may be taken into account by insurer(s) in order to prepare or modify insurance quotes. In some embodiments, answers 132 or other input (e.g., collaborative Web 2.0 feedback or content) collected from users may be analyzed in order to determine whether or not to underwrite a posted risk 125, for example, by an underwriting determinator module 148 which may be included in (or associated with) server 110 and/or insurer terminal 105.

In some embodiments, questions 131 and/or surveys may be selectively addressed to a group of users in order to poll their input regarding characteristics of the risk, as well as their confidence level in their opinion. Selective addressing of questions 131 and/or surveys to groups or communities of users may be based, for example, on user information as store in user profiles (e.g., collected in an optional user registration process). In some embodiments, optionally, user profiles are created automatically based on previous on-line experience with the user; or, user profiles are provided by or generated using other Web 2.0 services or components. In some embodiments, for example, questions 131 or surveys related to the risk associated with house contractors may be selectively directed to users whose profile indicates that their profession, education, geographical location, or other properties are particularly relevant to this field.

In some embodiments, customer terminals 101-103 allow customers to input rankings or ratings or scores associated with various insurers, for example, related to the insurer's history of honoring insurance claims, the time (e.g., in days) that it takes the insurer to process insurance claims, overall rating of customer satisfaction, free-text customer reviews or customer comments, or the like. The rankings, ratings and scores may be collected through a rating module 141, may be stored in the database 122 and may be reviewed, sorted, or otherwise presented to customers.

In some embodiments, insurer terminals 104-106 may share information regarding history of a customer, such that an insurer may examine past claims of a customer (in similar risks and/or in different risks). Similarly, information about history of insurance premium payment by the customer may be shared among the insurers, or may be stored in the database 122 for retrieval by the insurer terminals 104-106.

In a second demonstrative example, a customer considers to quit working as an employee and to open a bakery store in a new mall. The customer is willing to fund his new bakery store for up to one year, and expects the new bakery store to become profitable within one year. The customer utilizes system 100 to post a request in order to obtain insurance coverage for the risk that the new bakery store will go bankrupt within a year. Server 110 may identify and/or aggregate similar requests, and bring them to the attention of insurer(s); one or more insurers may then determine, separately or as syndication, whether or not to underwrite that risk. Optionally, server 110 may identify and aggregate similar insurance requests into a diversified set of risks which may be addressed by the insurer; for example, an insurance request regarding the risk of opening a new bakery store in a mall, an insurance request regarding the risk of opening a new barber shop in a mall, and an insurance request regarding the risk of opening a new flower store in a mall, may be aggregated into a risk type of “opening a new business in a mall” or “opening a new store”.

In response to the request to insure the risk of opening the new bakery store, insurer(s) may post questions to the requesting customer and/or to other users (e.g., “Have you ever started a new business?”, “Do you have any experience in the bakery industry?”, or “What is the monthly rent for the bakery store in the mall?”) and may receive answers, which may be used in order to identify common risk factors (e.g., to facilitate the underwriting of such risk) or to more efficiently underwrite the requested risk. Web-based architecture of system 100 may further be utilized by insurers to advertise the new risk for which insurance is sought, and to locate additional insurers in order to form a syndication. In some embodiments, the risk is aggregated using other criteria, for example, the risk of opening a bakery in a town, or the risk of expanding a bakery, or the risk of opening a “bread shop”.

In a third demonstrative example, a business entity needs to fulfill a large order of shirts, and considers hiring the services of a particular foreign shirt manufacturer. The business entity utilizes the system 100 in order to post a request in order to obtain insurance coverage for the risk that the foreign shirt manufacturer does not deliver the shirts on time. Server 110 may identify and/or aggregate similar requests, and bring them to the attention of insurer(s); one or more insurers may then determine, separately or as syndication, whether or not to underwrite that risk. Similarly, insurer(s) may utilize system 100 to obtain additional information about the particular foreign shirt manufacturer, about foreign shirt manufacturers in general, about foreign shirt manufacturers of particular countries, and other information to assist the insurer(s) in determining the risk for which insurance coverage is sought and in creating a diversified portfolio of insurance coverage for that risk.

In some embodiments, insurance underwriting may not require a large volume of statistics in order to evaluate the risk of occurrence of particular; and insurance underwriting may be provided to events lacking a large amount of data, or events lacking significant history associated therewith. Some embodiments allow to provide insurance for events that pertains to a small but significant segment of the population, even if conventional insurance processes were unsuccessful in determining the risk associated with those events. Furthermore, some embodiments may distinguish or differentiate between multiple similar events, which conventional insurance processes considered as the same event for purposes of insurance underwriting; some embodiments determine different risk profiles associated with the multiple seemingly-similar events.

Some embodiments utilize “Web 2.0” architecture or components, as well as collaborative techniques, in order to underwrite risks that are associated with smaller segments of the population or with “niche” populations, and/or to differentiate among sub-populations within a large risk pool, thereby allowing improved underwriting of insurance for these risks.

Some embodiments utilize “Web 2.0” architecture or components to allow insurance companies and other underwriters to rapidly discover emerging areas where many individuals (or organizations) seek insurance coverage, and to develop new insurance products in response to the determined market trends. Some embodiments allow insurers and customers to reduce the risk associated with a specific coverage request, for example, by facilitating to form syndications of multiple insurers to cover a risk (e.g., eight insurance companies combining to cover together a significant insurance amount for a particular risk, each insurance company covering 12.5 percent of the insurance amount and collecting 12.5 percent of the insurance premium).

In some embodiments, system 100 may include “Web 2.0 tools” 135 and/or other collaboration tools 136 to further facilitate the process of collaborative insurance. Such tools may utilize the Web as a platform and data as a driving force, and may create network effects by an architecture of participation.

In some embodiments, insurance requests or risk descriptions submitted by a first customer may be accessed by insurers and by other customers. In other embodiments, insurance requests or risk descriptions submitted by a first customer may be accessed by insurers but may not be accessed by other customers. In some embodiments, the customer may selectively grant access only to specific insurers (or types of insurers) and/or to other customers who meet specific criteria. In some embodiments, the customer does not disclose and does not publish all private or personal details, but rather, the customer requires the potential insurer(s) to first contact him, and he may then determine whether or not to disclose all details to such potential insurer(s).

In some embodiments, a risk analyzer module 137 may be used to analyze the submitted requests for insurance, and to aggregate them in accordance with different criteria (e.g., as defined by an insurer). The risk analyzer module 137 takes into account information submitted by the requesting customer, as well as information submitted by other customers or users (e.g., Web 2.0 community). The risk analyzer module 137 may estimate the exposure associated with the risk, as well as diversification of pools of aggregated insurance requests.

In some embodiments, system 100 may include an insurance policy generator module 138 to allow the customer and one or more insurers to make an insurance agreement, e.g., optionally utilizing a digital signature mechanism or other mechanisms to record the agreement in non-refutable manner.

In some embodiments, system 100 may include a claims processor module 139, allowing customers to submit insurance claims, and further allowing automated or semi-automated processing of insurance claims. Optionally, a claims setter module 140 allows an insurer to collaboratively reach an agreement with a customer with regard to insurance claims, to define the terms and conditions in which an insurance claim is to be paid, and to record the reached agreement in non-refutable manner.

In some embodiments, system 100 may allow customers to post their individual needs or requests for insurance; may automatically find and aggregate similar insurance requests (e.g., requests with similar risk features); may allow an insurer to directly issue a policy to a requesting customer, and may allow the parties to agree on exact terms and conditions under which a claim is to be paid; may allow a group or syndication of insurers to collaboratively underwrite a risk; may allow an insurer to query and receive collaborative input from multiple users of a community about the level of risk posed or about other characteristics of the risk for which insurance is sought; may automatically select appropriate community members to which the questions or surveys are selectively directed, and may aggregate results to assist the insurer in evaluating the risk; may allow a policy holder to electronically submit an insurance claim; may allow an insurer to electronically request additional information or proof that conditions for payment of the insurance amount are met; may allow customers to receive information about performance of different insurers (e.g., amount of risks underwritten, time from claim to payment, or the like) in order to determine reliability of an insurer; may allow a community of online users to rate the performance of different insurers; and/or may allow an insurer to gather or obtain additional information on the individual or organization requesting insurance (e.g., claims history, credit history, or the like).

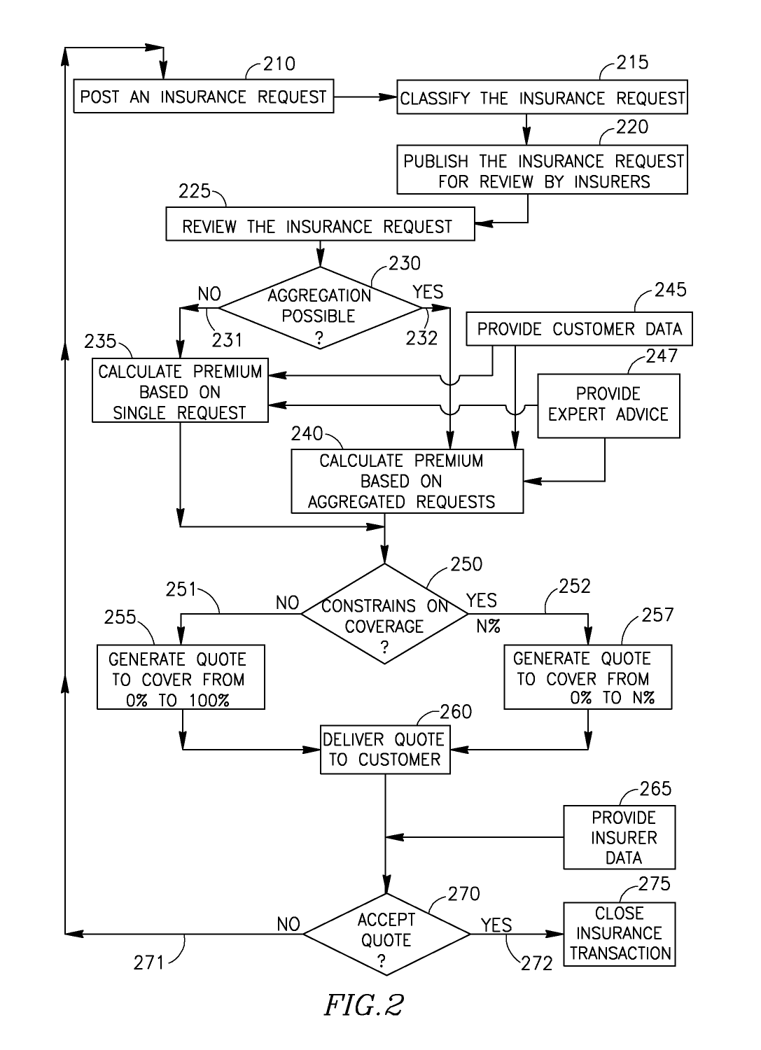

FIG. 2 is schematic flow-chart of a method of collaborative insurance in accordance with some demonstrative embodiments of the invention. Operations of the method may be used, for example, by system 100 of FIG. 1, and/or by other suitable units, devices and/or systems.

In some embodiments, for example, the operations of blocks 210 and 270 are performed by a customer through a customer terminal; the operations of blocks 215, 220, 245, 247, 260, 265 and 275 are performed by a clearinghouse server; and the operations of the other blocks are performed by one or more insurers through one or more insurer terminals.

In some embodiments, the method may include, for example, posting a risk-oriented insurance request, e.g., a description of a risk for which insurance coverage is sought (block 210).

In some embodiments, the method may include, for example, classifying the insurance request into one or more types (e.g., business related, homeowner related, or the like) (block 215).

In some embodiments, the method may include, for example, publishing the insurance request for review by potential insurers (block 220).

In some embodiments, the method may include, for example, reviewing the insurance request by one or more insurers (block 225). This may optionally include, for example, reviewing results returned by a common risk identifier module; reviewing results returned by a risk-of-interest identifier module; reviewing results returned by a module that searches for risks that match a profile defined by the insurer; reviewing results of a free-text search, a keyword search, a tag-based search; reviewing trend analysis results; sorting the information (e.g., according to risk amount, alphabetically, or the like); performing filtering-in operations or filtering-out operations to include or exclude certain risks or types of risks; or the like.

In some embodiments, the method may include, for example, checking whether the insurance request can be aggregated with similar insurance requests (block 230).

If the insurance request cannot be aggregated with other, similar, risk requests (arrow 231), or if no similar insurance requests are pending or available, then the method may include, for example, calculating an insurance premium amount for the insurance request based on the single insurance request (block 235).

In contrast, if the insurance request can be aggregated with other, similar, risk requests (arrow 232), then the method may include, for example, calculating an insurance premium amount for the insurance request based on an aggregation of multiple, similar, insurance requests (block 240).

In some embodiments, the calculation operations of blocks 235 and/or 240 may take into account, for example, data about insurance history of the customer, premium payment history of the customer, insurance claims history of the customer, credit history of the customer, and other customer rating data which may be received (block 245); as well as expert advice, poll or survey results, chat-room discussions, or other received input (block 247).

In some embodiments, the method may include, for example, checking whether or not there are constrains (e.g., pre-defined constrains) on the insurance coverage (block 250), e.g., constrains related to coverage percentage or to insurance amount.

If there are no constrains (arrow 251), then the method may include, for example, generating an insurance quote for a coverage of a fraction of the risk, the fraction greater than zero percent and equal to or smaller than 100 percent (block 255). In some embodiments, the insurance quote is generated by a single insurer; in other embodiments, the insurance quote is generated by a syndication of multiple insurers. In some embodiments, the generation of the insurance quote is conditioned on a prior determination of the insurer to offer an insurance quote (namely, a determination to underwrite the described risk); for example, an insurer may determine not to underwrite a described risk, and in such case an insurance quote is not generated and is not delivered to the customer.

In contrast, if there are constrains (arrow 252), then the method may include, for example, generating an insurance quote for a coverage of a fraction of the risk, the fraction greater than zero percent and equal to or smaller than N percent, wherein N percent denotes fraction of the risk to which the coverage is constrained (block 257). In some embodiments, the insurance quote is generated by a single insurer; in other embodiments, the insurance quote is generated by a syndication of multiple insurers. In some embodiments, the generation of the insurance quote is conditioned on a prior determination of the insurer to offer an insurance quote (namely, a determination to underwrite the described risk); for example, an insurer may determine not to underwrite a described risk, and in such case an insurance quote is not generated and is not delivered to the customer.

In some embodiments, the method may include, for example, delivering the insurance quote to the requesting customer (block 260), or otherwise publishing the insurance quote.

In some embodiments, the method may optionally include, for example, providing to the requesting customer information about the insurer (block 265), e.g., insurer history data, insurer financial data, insurer rating, or the like.

In some embodiments, the method may include, for example, checking whether the requesting customer accepts or rejects the insurance quote (block 270).

If the requesting customer rejects the insurance quote (arrow 271), then the method may optionally include, for example, repeating the operations of block 210 and onward; for example, an opportunity may be provided to the customer to modify his risk description, to make the risk description clearer or more favorable to insurers, to modify the types of insurers that are allowed to review his risk description, or the like.

In contrast, if the customer accepts the insurance quote (arrow 272), then the method may include, for example, closing the insurance transaction between the requesting customer and the insurer (block 275).

Other suitable operations or sets of operations may be used in accordance with embodiments of the invention.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments of the invention have been illustrated and described herein, many modifications, substitutions, changes, and equivalents may occur to those skilled in the art. It is, therefore, to be understood that the appended claims are intended to cover all such modifications and changes.

What is claimed is:

1. A system for electronic insurance transactions, the system comprising:
a server to receive a risk description posted through a customer terminal,
to publish the risk description to one or more insurer terminals, and
to determine whether or not to underwrite an insurance covering at least a portion of a risk included in the risk description based on an analysis of aggregated data,
wherein the aggregated data comprises data related to said risk description and data related to one or more other posted risk descriptions.

2. The system of claim 1, wherein the server is to automatically aggregate said risk description and said one or more other posted risk descriptions into a common risk based on aggregation rules.

3. The system of claim 1, wherein the server is to automatically identify a risk-of-interest from a plurality of posted risk descriptions based on a risk profile entered through an insurer terminal.

4. The system of claim 1, wherein the server comprises:
a polling module to electronically poll a plurality of users about the risk included in the risk description.

5. The system of claim 4, wherein the polling module is to selectively poll a sub-set of users of an online community of users based on a property of user profiles associated with said users.

6. The system of claim 1, comprising:
an insurance premium calculator module to calculate an insurance premium amount corresponding to the insurance covering at least a portion of the risk included in the risk description.

7. The system of claim 6, comprising:
an insurance quote generator to generate an insurance quote comprising the insurance premium amount and one or more other insurance terms.

8. The system of claim 7, wherein the server is to deliver to said customer terminal the insurance quote.

9. The system of claim 8, wherein the server is to receive from said customer terminal a signal indicating customer acceptance of the insurance quote.

10. The system of claim 9, wherein the server is to generate an insurance policy in response to the signal indicating customer acceptance of the insurance quote.

11. The system of claim 7, comprising:
a claim setter module to determine one or more conditions for payment of an insurance claim related to said risk, based on a collaborative exchange of information between the customer terminal and an insurer terminal.

12. The system of claim 1, comprising:
a rating module to collect from customer terminals ratings associated with performance of one or more insurers, and to present on said customer terminal one or more of the collected ratings.

13. The system of claim 1, comprising:
a rating module to collect from insurer terminals ratings associated with insurance-related behavior of one or more customers, and to present on an insurer terminal one or more of the collected ratings.

14. A method for electronic insurance transactions, the method comprising:
receiving a risk description posted through a customer terminal;
publishing the risk description to one or more insurer terminals; and
determining whether or not to underwrite an insurance covering at least a portion of a risk included in the risk description based on an analysis of aggregated data,
wherein the aggregated data comprises data related to said risk description and data related to one or more other posted risk descriptions.

15. The method of claim 14, comprising:
automatically aggregating said risk description and said one or more other risk descriptions into a common risk based on aggregation rules.

16. The method of claim 14, comprising:
automatically identifying a risk-of-interest from a plurality of posted risk descriptions based on a risk profile entered through an insurer terminal.

17. The method of claim 14, comprising:
selecting a sub-set of users of an online community of users based on a property of user profiles associated with said users; and
electronically polling the sub-set of users about the risk included in the risk description.

18. A computer program product comprising a computer useable medium including a computer readable program, wherein the computer readable program when executed on a computer causes the computer to perform a method comprising:
receiving a risk description posted through a customer terminal;
publishing the risk description to one or more insurer terminals; and
determining whether or not to underwrite an insurance covering at least a portion of a risk included in the risk description based on an analysis of aggregated data,
wherein the aggregated data comprises data related to said risk description and data related to one or more other posted risk descriptions.

19. The computer program product of claim 18, wherein the method comprises:
automatically aggregating said risk description and said one or more other risk descriptions into a common risk based on aggregation rules.

20. A server computer comprising:
a risk-posting module to receive risk descriptions from customer terminals;
a database to store posted risk descriptions;
a retrieval interface to selectively present on the insurer terminal a risk-of-interest based on a risk profile;
a question-posting module to receive from an insurer terminal a question related to the risk-of-interest; and
an answer-posting module to receive from one or more customer terminals one or more answers to the question.
